(19) United States
(12) Patent Application Publication
(10) Pub. No.: US 2008/0201723 A1
(43) Pub. Date: Aug. 21, 2008

(54) Method of Automatically Managing Associations Between Services in a Distributed Environment

(75) Inventors: André Bottaro, Grenoble (FR); Anne Gerodolle, Eybens (FR); Vincent Olive, Bernin (FR)

Correspondence Address: THORNE & HALAJIAN;APPLIED TECHNOLOGY CENTER, 111 WEST MAIN STREET, BAY SHORE, NY, 11706, US

(73) Assignee: FRANCE TELECOM, Paris (FR)

(21) Appl. No.: 12/089,909

(22) PCT Filed: Oct. 4, 2006
(86) PCT No.: PCT/FR06/50991

§ 371 Date: Apr. 10, 2008

(30) Foreign Application Priority Data
Oct. 11, 2005 (FR) 0553085

(51) Int. Cl. G06F 9/54

(52) U.S. Cl. 719/316

(57) ABSTRACT

The invention relates to a method of automatically managing associations in a distributed environment between components requesting services and components providing services, comprising the following steps: dynamically discovering required services by means of a distributed service discovery protocol, advertising services provided by means of a distributed service discovery protocol, and producing a connection between a component requesting services and a component providing services. According to the invention, for at least one of said components, said requested services and/or said provided services are declared in a declaration file associated with the component that is analyzed when starting that component on a platform forming part of the distributed environment. Application to home automation networks and small office automation networks.

The present invention relates to a method of automatically managing associations between components requesting services and components providing services in a distributed environment.

The invention finds a particularly advantageous application in the field of home automation networks, small business networks, and networks in a car, a boat, or a satellite.

It is now possible to install in the home a home automation network and electronic devices connected to that network. Such devices range from standard computers to domestic appliances (refrigerators, dishwashers, etc.) via personal digital assistants (PDA), smart phones, audiovisual equipment (televisions, video recorders, DVD players, etc.). The equipment in a small business network includes a printer, a scanner, a facsimile machine, application servers (messaging, business tools), a presentation viewer, for example. Sensors and actuators can also be installed and connected to such networks.

Consequently, the proposed invention is intended to be deployed in intelligent electronic devices in the home, in business, or in places where local area networks are used. There already exist technologies enabling equipment requiring services to discover and to be connected to equipment providing those services. By means of the invention, it is possible to develop applications independently of the discovery and interconnection technology chosen for the equipment concerned.

The method proposed by the invention is based on the service-oriented architecture concept, a development of object-oriented programming and component-based programming.

In substance, the service-oriented architecture concept stems from the idea that an application can be considered as combining services constituting “contracts” that service providers must comply with. Providers publish their identities and declare the services that they are in a position to offer, either on the basis of a directory of services or directly from a list of customers or service requesters discovered dynamically, or by broadcasting over a broadcast channel. Service requesters formulate requests either from the directory of services or directly from service providers discovered dynamically, for example by means of a broadcast enquiry, in order to discover and select the appropriate service provider. To obtain the service, the requester is connected to the required provider and can request that provider to perform actions offered in the contract.

These architectures are usually developed within the object paradigm. The services are interfaces. The service providers are objects from classes implementing those interfaces. Each service requester can be connected to a service provider discovered by any of the above methods and can then invoke the methods declared by the provider object via the interface.

Provider objects and requester objects can be parts of larger entities or can themselves made up of other lower-level objects. In this specification, the service requester or service provider objects are both called “components”. Note that, where appropriate, a component can simultaneously be a service requester and a provider of (another) service.

The advantage of service-oriented architectures is that they enable loose coupling between the entities that constitute them. They interact only through known and generically defined services that can be implemented, and therefore provided, in various ways. In this type of architecture, an entity can easily be replaced by another on condition only that it provides the same services.

A service-oriented architecture can be distributed or not. If it is distributed, the entities can be distributed between different equipment units. The connection between the entities then uses a telecommunications protocol.

A prior art Service Binder mechanism automates management of service dependencies on a non-distributed Java services platform called OSGi. This system can adapt an application dynamically on the basis of information provided by the components that constitute it. Applications constructed in this way can be assembled and adapted dynamically.

Designed on top of an OSGi component model, the Service Binder mechanism automates the discovery of services and the connection between components deployed on the OSGi platform. Each component is associated with a descriptive file of services provided and requested that is analyzed by the Service Binder mechanism. This analysis enables automatic adaptation of each component to the changing composition of the platform: uninstallation of components or installation of new components, storage or elimination of services.

It is important to note that, because the OSGi services platform is itself non-distributed, this system is adapted to the construction of non-distributed applications.

There are also prior art technologies that can be used in a distributed data processing environment.

Consider, for example, the technology proposed in application WO 01/86419 in the name of Sun Microsystems. In the service discovery process described in that application, a “client” sends a request including search criteria that are then compared to service offers in the distributed environment, and the client then receives messages indicating service offers conforming to its search criteria. Service requests and service offers are expressed in an appropriate data representation language, for example the eXtensible Markup Language (XML). Note that, to enable discovery of remote services and their use according to the application WO 01/86419, it is necessary for a developer associated with the client to write and send a series of messages that use the methods of a dedicated “API layer 102” interface. That technology therefore necessarily calls for human intervention during execution.

The paper by P. Grace, G. S. Blair and S. Samuel “A Reflective Framework for Discovery and Interaction in Heterogeneous Mobile Environments” (ACM Sigmobile Mobile Computing and Communications Review, vol. 9(1), pages 2 to 14, January 2005) touches on the problem of interworking between existing protocols and proposes a “Reflective Middleware to Support Mobile Client Operability” (ReMMoC) platform.

Although the ReMMoC technology solves the problem of compatibility between different service discovery technologies and between different telecommunication technologies, it does not address the problem of automating management of service dependencies, and using the ReMMoC platform for a service search requires the intervention of a developer.

Moreover, the ReMMoC platform does not offer the possibility of using only local methods when the services are provided by the same machine, although local method invocation in a programming language is much faster than remote method invocation.

The prior art universal plug and play (UPnP/SSDP) technology is based on a distributed architecture offering dynamic services for network peripherals (television, lighting, ADSL router, DVD player, roller blinds, etc.) and control points (PDA, television, wall switch, etc.) interconnected by an ad hoc network. The UPnP/SSDP technology defines its service discovery protocols. Its telecommunications protocols are borrowed from the Simple Object Access Protocol (SOAP). Once again, no mechanism is provided for automating discovery of required services.

Also known in the art are Web Services software systems whose architecture was developed to enable heterogeneous applications executing in different businesses to be able to interwork via services offered by the applications. The heterogeneous nature of the applications is considered not only at the level of the application implementation languages but also at the level of the interworking models defined by the communications protocols.

Web Services are described in the Web Service Description Language (WSDL). That language, which is based on an XML grammar, is used to describe the interface of the service, the types of data employed in messages, the transport protocol used to communicate, and information for locating the specified service. The Universal Description and Discovery and Integration (UDDI) directory of services accepts storage of service descriptions (called service types) and of business service providers. The default communications protocol is SOAP.

To summarize, numerous technologies now enable interconnection of electronic equipment via a network and disconnection from the network without disrupting its overall operation: distributed service discovery protocols such as Jini (from Sun Microsystems), UPnP, Web Services, and the like enable equipment to advertise services and to discover services provided on the network, in particular those that it needs. Those technologies also provide the means for connecting clients and service providers using remote connection protocols such as SOAP used by UPnP and Web Services, RMI used by Jini, and CORBA/IIOP used by CORBA.

Those technologies connect a service provider component and a service requester component located at different nodes of the network. However, the programmer must write non-functional code, i.e. code associated with a concern outside the primary functions of the software, such as:
programming the search for a service having properties that the service requester is looking for;
putting on hold certain processes such as activating and advertising services provided until the services are available; and
detecting and processing service storage, elimination and modification events.

The Service Binder mechanism described above processes those aspects specifically, but in an OSGi non-distributed context, because it is responsible for assembling and disassembling components as a function of criteria described in a metadata file conforming to an XML syntax: services provided and associated properties, services required with their acceptability criteria (filters).

To summarize, it is found that no technical solution known at present provides for automatic management of service dependencies between providers and requesters in a distributed environment.

The invention therefore proposes a method of automatically managing associations in a distributed environment between components requesting services and components providing services, the method comprising the following steps:
dynamically discovering required services by means of a distributed service discovery protocol;
using a distributed service discovery protocol to advertise provided services; and
producing a connection between a component requesting services and a component providing services.

This method is noteworthy in that, for at least one of said components, said requested services and/or said provided services are declared in a declaration file associated with the component that is analyzed when starting that component on a platform forming part of said distributed environment.

Thus the invention implements automatic management of provider-requester associations on the basis of a prior declaration of dependencies of services of each component, i.e. of services provided and/or requested by each component of the application. For example, this prior declaration can advantageously be written in a simple syntax, such as the XML syntax. For example, service discovery can result from a request presented by a client application or reception of an unsolicited advertisement sent out by a service provider.

In a correlated way, the invention therefore relates to a declaration file in which services requested and/or services provided by a component associated with said file are declared, characterized in that it is adapted to be analyzed by a manager object during the starting of said component on a platform forming part of a distributed environment.

According to particular features, the method of the invention may further comprise a step of eliminating a connection between a component requesting a service and a component that previously provided the service if the component that previously provided the service is no longer in a position to provide the service.

This has the advantage that one or more connections that have become of no use can be eliminated.

The invention also has the advantage of enabling the developer to produce an application independently of the service discovery technologies and communication technologies present on the network during execution. The invention therefore enables transparent use of all existing discovery protocols and all existing communications protocols without being limited to a unique representative of those protocols.

In particular, the invention is compatible with all distributed service discovery protocol types. For example, one or more distributed service discovery protocols can be chosen from the SLP, Jini, UDDI, UPnP/SSDP, CORBA, and WS-SD protocols.

In one embodiment, for at least one service requester/service provider pair, said connection is effected by means of a telecommunications protocol. For example, said telecommunications protocol can be chosen from the RMI, SOAP, and CORBA/IIOP protocols.

In this embodiment, certain components using the telecommunications protocol and/or certain components using a distributed service discovery protocol can advantageously be installed by automatically downloading them as a function of predetermined events, such as the creation of a connection between two components or the installation of a component declaring a service.

Moreover, in one embodiment, for at least one service requester/service provider pair hosted by the same platform, said connection is provided by means of a local call.

As explained above, the invention is intended to be used in a distributed environment. For this reason it also relates to a platform forming part of a distributed environment and comprising:
a component associated with a declaration file in which services requested and/or services provided by the component are declared; and
a manager object adapted to analyze said declaration file on starting of the component concerned on said platform.

The invention is also directed to computer programs.

It therefore relates, firstly, to a core computer program comprising program code instructions for interpreting declaration files of services requested by a service requester component and declaration files of services provided by a service provider component in a distributed environment and for choosing from the protocols available a communications protocol compatible with said service requester component and said service provider component when said core program is executed by a computer.

Thus the core program is able to identify which services can be the subject of an association between a service requester and a service provider. This program has the advantage that it does not need to know in detail which service discovery protocols and which types of communication are available.

For this reason the invention relates, secondly, to an implementation computer program adapted to be called by a core program as succinctly described above, comprising program code instructions for implementing a distributed service discovery protocol and/or a telecommunications protocol when said implementation program is executed by a computer.

Providing a core program (installed on all platforms) and implementation programs (which need be installed on certain platforms only) has the advantage of not imposing management of the complete computer program required to implement the invention on all nodes of the system. It is nevertheless clear that this arrangement of programs having different functions is mentioned here only as a preference and is in no way essential to implementing the invention.

The following description with reference to the appended drawings of embodiments given by way of non-limiting example explains clearly in what the invention consists and how it can be reduced to practice.

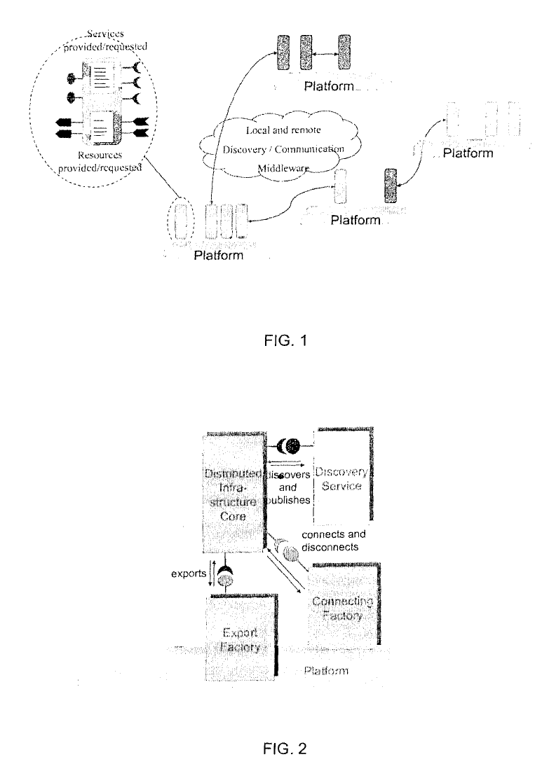

FIG. 1 a functional diagram of an application on a plurality of distributed platforms.

FIG. 2 is a diagram of the core of the infrastructure adapted to a single service discovery protocol and a single communications protocol in accordance with a first embodiment of the invention.

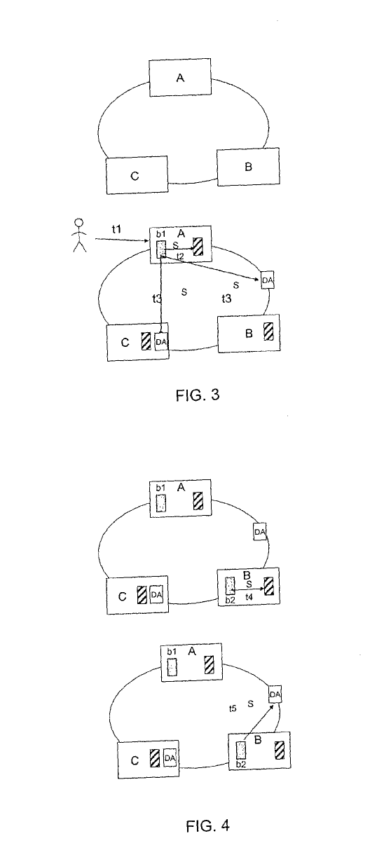

FIG. 3 is a diagram relating to the publication of a service in accordance with the first embodiment of the invention.

FIG. 4 is a diagram relating to the discovery of a stored service in accordance with the first embodiment of the invention.

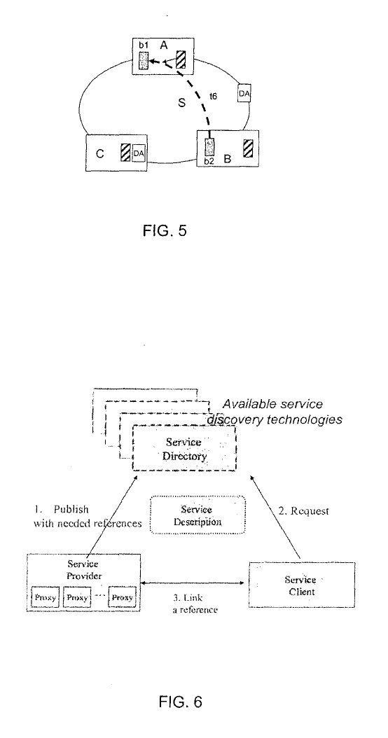

FIG. 5 is a diagram relating to remote invocation of methods of a service provider in accordance with a first embodiment of the invention.

FIG. 6 is a diagram of the mechanisms used in a second embodiment of the invention.

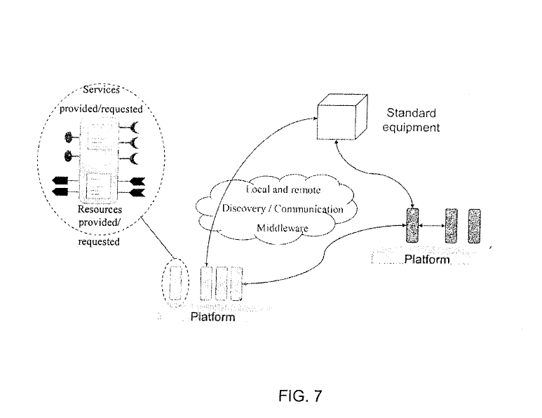

FIG. 7 is a functional diagram of an application on a plurality of distributed platforms and a plurality of equipments.

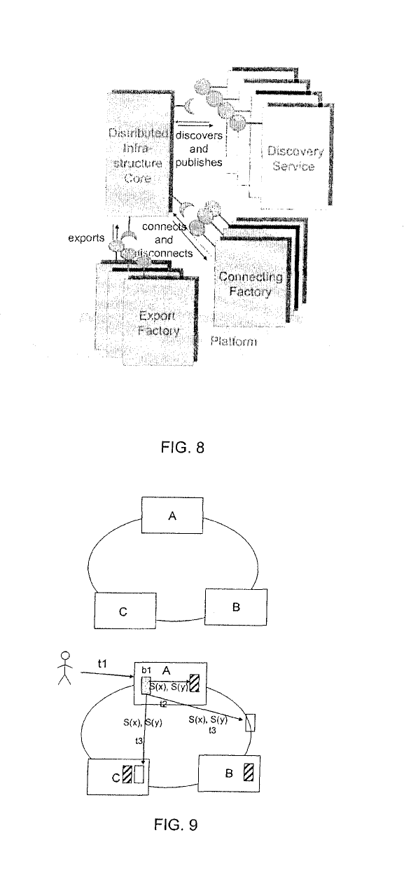

FIG. 8 is a diagram of the core of the infrastructure adapted to multiple technologies in accordance with the second embodiment of the invention.

FIG. 9 is a diagram relating to the publication of a service in accordance with the second embodiment of the invention.

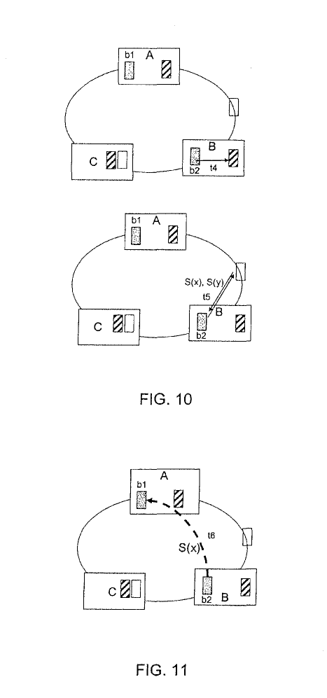

FIG. 10 is a diagram relating to the discovery of a stored service in accordance with the second embodiment of the invention.

FIG. 11 is a diagram relating to remote invocation of methods of a service provider in accordance with a second embodiment of the invention.

A first embodiment of the invention comprising a single service discovery protocol and a single telecommunications protocol on top of an OSGi-type service platform is described in detail next. The OSGi environment provides a practical embodiment of the invention, which can encompass any execution environment with components based on a service equivalent to that of the Service Binder mechanism.

In the particular circumstance of the OSGi platform, the “bundle” technology is used to define a deployment unit or a software element that can be deployed on the platform. The invention consists in a set of bundles that can be deployed in full or in part at each of the nodes of a network of intelligent electronic equipments such as computers.

The proposed embodiment comprises a set of classes and generic interfaces defining basic processes in a distributed environment, such as export, connection, discovery, namely:
ExportFactory object concept: all classes and interfaces useful for the export process. The function of an ExportFactory object is to fabricate for any object an export reference containing all the information enabling that object to be reached from a node of the network, for example a URL;
ConnectionFactory object concept: all classes and interfaces useful for the connection process. The function of a ConnectionFactory object is to fabricate from an export reference a connection object for invoking the methods of the remote object;
discovery service concept: all classes and interfaces useful for implementing the discovery service concept; the function of the discovery service is to enable servers to publish service references on the network and clients to discover services published in this way.

These interfaces and classes can be provided in a single bundle, for the fastest deployment, or in a number of separate bundles, for modular maintenance. This bundle or set of bundles is necessary on each platform using the invention. All these interfaces can be included in one component, such as the distributed infrastructure core shown in FIG. 2.

The implementation bundles provide:
an implementation of the discovery service interface that uses the Service Location Protocol (SLP) or any other chosen protocol as the distributed service discovery protocol to extend service discovery to a number of platforms;
an implementation of the ConnectionFactory object interface using a telecommunications protocol, such as remote method invocation (RMI); and
an implementation of the ExportFactory object interface using said telecommunications protocol.

The Service Binder mechanisms are adopted and extended with distributed mechanisms. The life cycle of the components is respected. Each component described in the descriptive file is therefore attached to an automatic dependencies manager. Each time that the dependencies manager of a component effects a discovery or service connection operation, the mechanism is extended in the following manner:
The search for a required type of service taking account of the properties defined by the component is first effected locally on the platform. If a sufficient number of providers of the service is found, the search is deemed conclusive and interrupted. The connections to the components discovered are then exclusively local connections. If the number of service providers discovered on the platform is not sufficient and if the description of the dependency mentions that it could be satisfied remotely, for example by means of a Boolean value added to the syntax of the description, the manager then effects the request using the discovery protocol mentioned above. If the references discovered are suitable, the manager calls the ConnectionFactory object to obtain a representative of the service provider remote object (the object implementing the service interface) to the requesting component. Thus a “remote” connection is effected. The interface of the object obtained in the case of a remote connection is in every way similar to that of the object that would be obtained if the provider were local. The difference is that the object obtained processes requests as a proxy and forwards requests to the remote object.
A service provided is stored first on the local platform. If the descriptive file of the component mentions that the service can be offered remotely, then the manager calls the ExportFactory object to construct an export reference and then stores that reference in accordance with the discovery protocol. The export reference of the component contains information sufficient for the ConnectionFactory object present on a client to construct a proxy enabling access to the remote component.

Writing the core code requires only a knowledge of the basic interfaces described above. In FIG. 2, the basic interfaces and the core code are combined in the distributed infrastructure core bundle. For operation in distributed mode, the core needs to be installed on each OSGi platform, the RMI ConnectionFactory object bundle for the services requested, the RMI ExportFactory object bundle for the services provided, and the bundle enabling access to SLP discovery (FIG. 2). In FIG. 1, the core of the infrastructure is not represented on each platform, but each bundle installed uses the mechanisms offered by the infrastructure core.

The distributed mechanism of the method conforming to the first embodiment of the invention is described next with reference to FIGS. 3, 4, and 5.

FIG. 3 shows three platforms A, B, and C on the same local area network. The user requests installation of an application. Installation comprises installation of the bundle b1 on the platform A (t1). Via the infrastructure core, one of the components of this bundle stores a service S in the directory of services associated with the platform A (t2), and then stores it in remote directories known as directory agents (DA), an entity defined by SLP (t3).

FIG. 4 shows the presence of the bundle b2 on the platform B, one component of which is in the process of formulating a service request. The request is initially a local request (t4). In this example, either the required service S is not stored on the platform B or the description of the bundle b2 indicates that it requires connection to all providers of this service. Consequently, the bundle b2 addresses itself to one of the remote directories DA (t5). As the reference stored by b1 is suitable, the requesting component analyses the RMI parameters attached to the reference to invoke the methods on the remote service (t6) on the platform A, as shown in FIG. 5.

The proposed invention is intended to be installed in intelligent electronic devices in the home, in business or in the context of local area networks. Such devices are usually shipped with a standard component architecture. Architecture components and application components can be installed remotely as required. For good operation, the bundles defining the basic interfaces and the distributed infrastructure core must be installed on each platform that is to effect remote connections or to require remote services.

Developers usually define the service interfaces internal or external to their application first. These interfaces in all service-oriented models are defined by:
an interface name;
names of methods, also called actions or functions, with their entry and return arguments.

They then write the code of the application using these interfaces. A portion of the code is usually attached to the discovery technologies and remote connection technologies used. In the context of the invention, developers writes the code of their components using a standard programming model (here OSGi). Only one particular descriptive file is added to each component in order to declare the services to be provided in a distributed manner and the requested services. The invention generates automatically proxy objects, i.e. intermediaries useful for adapting discovery and communication to the target model. The code is therefore generic and is automatically adapted to discovery and connection of remote services.

The descriptive file is also useful at run time. According to the invention, a “manager” object analyses the file when the component is started. For each service requested, it activates an object that dynamically maintains knowledge of the providers that are available by using available discovery technologies, and connects the requester component to the providers or disconnects them. As soon as all the requested services have been provided, the manager advertises the services provided by the discovery technology, used to advertise or store services in this case. Applications are composed spontaneously with no explicit configuration before execution. During execution, the consequence of modification of the environment (user commands, installation and removal of devices, etc.) is the appearance or elimination of services. Because each component reacts dynamically to these events, the application is reconfigured automatically.

In particular, there can advantageously be provision for eliminating one or more connections between components requesting a service and a component that previously provided that service and that has made it known that it will no longer be in a position to provide the service from a given time.

As a general rule, administrators install their devices provided with their service platform. They can install the distributed infrastructure core and the units implementing the ExportFactory object, the ConnectionFactory object, and access to the remote discovery service directly or remotely.

Users can install application components on platforms on which the invention is installed, for example using a catalogue available on the Internet, deployment being a problem that is not addressed by the invention. With no prior configuration, the devices publish the services provided, discover the services available, and interwork with each other in order to offer all the functions of the required application.

A second embodiment of the invention combining all possible technologies for service discovery and telecommunication on an OSGi-type service platform is described in detail next. This second embodiment extends the first embodiment to a service-oriented architecture using all available service discovery and telecommunications protocols (FIG. 6).

The proposed embodiment comprises a set of generic interfaces and classes defining the basic processes, namely:
ExportMetaFactory object concept: the function of an ExportMetaFactory object is to maintain an up-to-date list of ExportFactory objects available on the platform; the metafactory object can call all available ExportFactory objects to create and attach parameters useful for the various telecommunication technologies for each storage of a service provided;
ConnectionMetaFactory object concept: the function of a ConnectionMetaFactory object is to maintain an up-to-date list of ConnectionFactory objects available on the platform; the metafactory object can create the appropriate remote connection from the known reference of a remote object; and
discovery metaservice concept: the function of this entity is maintain an up-to-date list of discovery services; it enables service providers to publish service references on the network according to all service discovery technologies present, and clients to discover services published in this way.

These interfaces and classes can be provided in a single bundle or in a number of separate bundles. This bundle (or set of bundles) must be present on each platform using the invention. All these interfaces can be included in one component, such as the distributed infrastructure core in FIG. 8.

The implementation bundles implementing the concepts defined above in the basic bundles are, for example:
specialized ExportFactory objects (RMI, SOAP for UPnP services, SOAP for Web Services, CORBA/IIOP) implementing the basic interfaces;
dedicated ConnectionFactory objects (same technologies as above) implementing the basic interfaces; and
bundles containing components implementing the discovery service concept using a standard discovery protocol (SLP, Jini, WS-SD, UDDI, UPnP/SSDP, CORBA Trading Service) or an ad hoc discovery protocol, for example based on a peer-to-peer technology.

For a requester operating on a platform A to be able to use a provider operating on another platform B, it suffices for there to be deployed on platform A a ConnectionFactory object compatible with an ExportFactory object deployed on platform B. Similarly, for the requester to be able to discover the provider, it suffices for a bundle encapsulating the same discovery protocol to be deployed on both platforms. If the client (respectively server) uses standard technologies, the server (respectively client) must also use the same discovery, export and connection technologies.

This second embodiment of the invention proposes generic mechanisms and interfaces for adapting the method of the first embodiment described above to all service discovery technologies and all telecommunication technologies.

The mechanisms of the first embodiment of the method are adopted and extended to adapt it to varied technologies. Each component developed is described in the descriptive file and has an automatic dependency manager attached to it. Each time that the dependency manager of a component effects a service connection or discovery operation, the mechanism is extended to all pertinent protocols present. The core bundle itself consists of three components:
a component implementing the discovery metaservice locally requiring all installed components providing a discovery service;
a component implementing the ConnectionMetaFactory object requiring locally all installed components providing a ConnectionFactory object; and
a component implementing the ExportMetaFactory object requiring locally all installed components providing an ExportFactory object.

The code of the core bundle uses these three components to implement the following distributed mechanisms.

As in the first embodiment of the method, the search for a type of service required taking account of the properties defined by the component is first effected locally on the platform. If the description of the dependency indicates that it could be satisfied remotely, for example by a Boolean value added to the syntax of the description, the manager then makes the request successively to each available discovery service. After each request, if the service providers discovered agree and can be connected to the requesting component, the search is declared conclusive and is interrupted.

A discovered service provider can be connected to the requesting component provided that the discovered provider is stored with at least one export reference compatible with an available ConnectionFactory object on the gateway known to the core. The compatible ConnectionFactory object then obtains for the requesting component a representative of the service provider remote object, namely an object implementing the service interface, based on usable parameters included in the export reference. The interface of the object obtained is in every respect similar to that of the object that would be obtained if the provider were local. The difference is that the object processes requests as a proxy and forwards requests to the remote object.

As in the first embodiment of the invention, a service provided is first stored on the local platform. If the descriptive file of the component indicates that the service can be offered remotely, then storage is effected successively with each available discovery service on the platform known to the core. The component is then stored with export references constructed by each ExportFactory object available on the platform known to the core.

To write the code of the core it is necessary to know only the basic interfaces described above. In FIG. 8, the basic interfaces and the code of the core are grouped together in the distributed infrastructure core bundle. For operation in distributed mode, the core requires there to be installed on each OSGi platform one or more ConnectionFactory object bundles for the services requested, one or more ExportFactory object bundles for the services provided, and one or more bundles proposing a discovery service (FIG. 7). In FIG. 7, the core of the infrastructure is not represented on each platform, but each installed bundle uses the mechanisms offered by the infrastructure core.

The distribution mechanism of the second embodiment of the method of the invention is described next with reference to FIGS. 9, 10, and 11.

FIG. 9 shows three platforms A, B, C on the same local area network. The user requests installation of an application. This entails installing the bundle b1 on the platform A (t1). Via the infrastructure core, one of the components of this bundle stores a service S in the directory of services associated with the platform A (t2), and then stores it in remote directories according to the available discovery services (t3). The storage associates export references according to different communications protocols (here x and y).

FIG. 10 shows the bundle b2 present on the platform B, one component of which is formulating a service request. The request is initially local (t4). In this example, either the service S requested is not stored on the platform B or the description of the bundle b2 indicates that it requires connection to all providers of this service, even remote providers. Consequently, the core sends the request successively to each discovery service; in FIG. 10, a request is sent to an external directory (t5), for example. As the reference stored by the bundle b1 is suitable, the requesting component then analyses the remote references. The bundle b2 retains the reference associated with the appropriate communications protocol x for invoking the methods on the remote service (t6) (FIG. 11).

The second embodiment of the invention is intended to be installed on intelligent electronic devices in the home, in business or in local area networks. Such equipment is usually shipped with a standard architecture. Architecture components and application components can be installed remotely if required. For good operation, the bundles describing the basic interfaces and the distributed infrastructure core must be installed on each platform intended to effect remote connections or request remote services. Each platform can then accommodate some or all of the available implementation bundles, as a function of the requirements and capacities of the platform: typically, all available implementation bundles would be installed on a PC, whereas only a subset would be installed in an embedded system with limited memory capacity.

Developers usually define the interfaces of services internal or external to an application first. In all service-oriented models these interfaces are defined by:
an interface name; and
names of methods, also called actions or functions, with their entry and return arguments.

A portion of the code is usually attached to the discovery technologies and remote connection technologies used. In the context of the invention, developers write the code of their components using a standard programming model (here OSGi). Only one particular descriptive file is added to each component in order to declare the services to be provided in a distributed manner and the services required. The invention generates automatically proxy objects, i.e. intermediaries useful for adaptation of discovery and communication to the target multiple models (FIG. 6). The code is therefore generic and is automatically adapted to the discovery and connection of remote services, provided that the corresponding adapters have been developed.

The descriptive file is used for execution. A manager object analyses this file when the component is started. For each service requested, it activates an object that dynamically maintains the known available providers using the available discovery technologies and connects the component to the providers or disconnects them. As soon as all requested services have been provided, the manager announces the services provided by all the available discovery technologies used to advertise or store services in this case. Applications are composed spontaneously with no explicit configuration before execution. During execution, the consequence of modification of the environment (user commands, incoming and outgoing equipment, etc.) is the introduction or elimination of services. Because each component reacts dynamically to these events, the application is reconfigured automatically.

In particular, it would be advantageous to provide for the elimination of one or more connections between components requesting a service and a component that previously provided that service and has made it known that it will no longer be in a position to provide the service from a given time.

Two sorts of application in particular can be constructed:
applications operating in accordance with the first embodiment for a single service discovery protocol and a single communications protocol; and
applications according to the second embodiment using a plurality of heterogeneous devices employing different service discovery or remote connection technologies; some of these applications can be developed in the standard manner; after downloading and starting the components in the gateway, they are discovered, discover pre-existing devices (i.e. devices operating by means of a development code independently of the invention and using standard discovery and telecommunication mechanisms), and are interconnected in order to make the various functions of the application possible, whatever the technologies present.

Connections are modified or added dynamically if other components of the proposed model or other devices publish their services on the network. The corresponding connections are broken or modified if components of the proposed model or equipments leave the network.

Users can already have devices advertising their services using various standard technologies (Jini, UPnP, Web Services, etc.). They do not need to know the details of these technologies. They also have at least one electronic device such as a computer in which the invention is installed. Users can install application components on the platforms on which the invention is installed, for example using a catalogue available on the Internet, deployment being a problem that is not addressed by the invention. Without prior configuration, the devices publish the services provided in accordance with the technologies known to them, publish their own services using the technologies available, and interact to offer all the functions of the required application.

Numerous uses of the invention can be envisaged:
office automation applications (printer, scanner, facsimile machine, etc.): in the office, as at home, many devices are shared or combined for various applications; some of these devices advertise themselves spontaneously on the network using standard technologies (Jini, UPnP, Web Services, CORBA, etc.); installing the invention on a computer enables discovery and use of these devices; the computer can propose spontaneously, i.e. without previous configuration, printing of documents on a UPnP or Jini printer, etc.; also, it can combine services offered even if the devices provided are not compatible a priori; for example, the service offered by a CORBA scanner could be combined with the printing service offered by a Jini printer to offer a photocopying service;
home automation applications (heating, ventilation, air conditioning, lighting, curtains, blinds, etc.): the invention combines home automation services offered by various technologies; if the home automation devices are programmed to be discovered using known protocols, the invention enables them to be discovered and combined services to be offered; one application example is programming the starting of devices according to time; for example, one hour before the alarm clock rings in the morning, Web Services radiators are started up, and as soon as the alarm clock rings, the UPnP coffee machine switches on and the Jini toaster can start to toast two slices of bread;
audiovisual applications (remote control, content sharing, reproduction): audiovisual applications can be combined; the corresponding devices can be content servers (media servers), reproduction devices (media renderers), or devices such as a set-top-box that connects a television to the Internet network; multimedia content servers and rendering services are distributed around the house and can be discovered and connected; a computer or a personal digital assistant equipped with the invention can offer an application that discovers all devices; the application explores multimedia contents, transfers contents from one storage space to another, and displays an element on a reproduction device such as a television in the living room or a computer in the bedroom;
external services: at present, numerous services are offered on the Internet in the form of Web Services; it is therefore possible to use the invention to develop applications that use services discovered and combine them with services of the local area network; for example, a malfunction of the UPnP washing machine can be identified and notified to an appliance monitoring service that alerts the user by sending a message to the user's personal digital assistant, which can contact Web Services offered on the Internet (Yellow Pages or manufacturer's after-sales service department) in order to offer a list of possible solutions to remedy the malfunction; the solution could be to call the nearest repairer or to notify the after-sales service department directly, which can then suggest what to do.

1. A method of automatically managing associations in a distributed environment between components requesting services and components providing services, the method comprising the following steps:
dynamically discovering required services by means of a distributed service discovery protocol;
using a distributed service discovery protocol to advertise provided services; and
producing a connection between a component requesting services and a component providing services;
characterized in that, for each component being integrated in a local platform (A, B, C) forming part of a distributed environment:
at least one of said components is associated with a declaration file in which said requested services and/or said provided services are declared; and
when said at least one component is started, the declaration file is analyzed on the platform (A, B, C) in which the component is integrated.

2. A method according to claim 1, characterized in that it further comprises a step of eliminating a connection between a component requesting a service and a component that previously provided the service if the component that previously provided the service is no longer in a position to provide the service.

3. A method according to claim 1, characterized in that, for at least one service requester/service provider pair, said connection is effected by means of a telecommunications protocol.

4. A method according to claim 3, characterized in that said telecommunications protocol is chosen from the RMI, SOAP, and CORBA/IIOP protocols.

5. A method according to claim 3, characterized in that a component using a telecommunications protocol is installed by downloading it automatically as a function of predetermined events.

6. A method according to claim 3, characterized in that a component using a distributed service discovery protocol is installed by downloading it automatically as a function of predetermined events.

7. A method according to claim 1, characterized in that, for at least one service requester/service provider pair hosted by the same platform (A, B, C), said connection is provided by means of a local call.

8. A method according to claim 1, characterized in that said service declaration is effected in XML syntax.

9. A method according to claim 1, characterized in that said a distributed service discovery protocol is chosen from the SLP, Jini, UDDI, UPnP/SSDP, CORBA, and WS-SD protocols.

10. A core computer program comprising program code instructions for interpreting declaration files of services requested by a service requester component and declaration files of services provided by a service provider component in a distributed environment and for choosing from the protocols available a communications protocol compatible with said service requester component and said service provider component when said core program is executed by a computer.

11. An implementation computer program adapted to be called by a core program according to claim 10, comprising program code instructions for implementing a distributed service discovery protocol and/or a telecommunications protocol when said implementation program is executed by a computer.

12. A declaration file in which services requested and/or services provided by a component associated with said file are declared, characterized in that it is adapted to be analyzed by a manager object during the starting of said component on a platform (A, B, C) forming part of a distributed environment.

13. A platform forming part of a distributed environment;
comprising:
a component associated with a declaration file in which services requested and/or services provided by the component are declared; and
a manager object adapted to analyze said declaration file on starting of the component concerned on said platform.

14. A method according to claim 1, characterized in that, after said declaration file has been analyzed on the platform (A, B, C), there is provided, for at least one required service declared in said file, a step of dynamically maintaining knowledge of provider components that are available and, where appropriate, a step of connecting said component under consideration to an available provider component in order to provide said required service.

15. A method according to claim 1, characterized in that, after said declaration file has been analyzed within the platform (A, B, C), there is provided, for at least one provided service declared in said file, a step of advertising said provided service on the distributed environment.
